(19) United States
(12) Patent Application Publication
(10) Pub. No.: US 2003/0078871 A1
(43) Pub. Date: Apr. 24, 2003

(54) Method and system of competitive auction

(75) Inventor: Derek J. Webb, Derby (GB)

Correspondence Address: NIXON & VANDERHYE P.C., 8th Floor, 1100 North Glebe Rd., Arlington, VA, 22201-4714, US

(73) Assignee: Prime Table Games LLC.

(21) Appl. No.: 09/983,198

(22) Filed: Oct. 23, 2001

(51) Int. Cl. G06F 17/60

(52) U.S. Cl. 705/37

(57) ABSTRACT

A competitive auction incorporates a quiz format to determine allocation of auctioned items. Participants each pay a participation fee each time an auction is entered for each item. The participants then each guess an average price estimate for the item among the participants. The closest estimate wins the auction for that item. Tied winning estimates are processed in subsequent rounds in various ways. In one operating mode, the participation fees are required to cover the cost of the auctioned item sufficiently enough to provide a profit to the auction venue or sponsor. This methodology provides much broader access to high cost items while adding a competitive game element to the auction process.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE) cl BACKGROUND OF THE INVENTION

The present invention relates to auction methodology and, more particularly, to a system and method for conducting a competitive auction combining aspects of auction and quiz game in a model to enable products to be offered to a broader marketplace than previously available.

Traditional auctions remain popular for items such as livestock, cars, property, furniture, works of art and the like. These items are almost always previously owned items, and it is unusual to see new items of such nature in auction. Many people are deterred from participating for fear of not understanding the auction process.

Internet auction sites have recently grown in popularity. The requirement to visit a live auction site in order to participate is circumvented by the technology. This of course applies to video links at traditional auctions. Internet auction sites have some advantages over traditional auction sites. Firstly, the potential marketplace is larger. Secondly, there is less intimidation for the first time participant. Thirdly, the economies of internet usage allow a broader range of products at lower price points to be viably auctioned.

There is also a wider range of quiz games available today than ever. Trivial Pursuit is still popular as are newer games like Cranium. Prime time trivia television programs have broadened the appeal of quiz games, and quiz nights and the like are popular in gathering establishments. Many people are also willing to play quiz games in an internet format. This may be a quiz dedicated to a specific area of knowledge, for example, a specific genre of pop music.

Another popular television format is the antique program. In one program, participants estimate the price or value of the selected antiques.

It would be desirable to combine these popular components into a competitive quiz game auction method, where participants can “win” auction items in a game format.

### BRIEF SUMMARY OF THE INVENTION

A goal of the invention is to create a business method of enabling wide participation in an auction style purchase of new and used items using a quiz-type format to determine allocation of the auctioned items. The invention requires each participant to pay a fee each time an auction is entered for each item. Each participant estimates the average price offered by all participants, and the closest estimate wins the auction for that item. Participants bidding for a next item do so by paying the requisite participation fee.

In the event of a tied estimate, then the tied participants are invited to submit a new estimate. In this context, there could be complete freedom of choice with respect to the second estimate or there could be restrictions. Second round ties could be resolved similarly in a third round, or alternatively, second round ties could incorporate fractional pricing (e.g., using dollar values less than $1 or possibly less than 1¢). Fractional pricing could also be permitted in all rounds, or only the second round onward.

### BRIEF DESCRIPTION OF THE DRAWINGS

These and other features and advantages of the present invention will be described in detail with reference to the accompanying drawings, in which:

FIG. 1 is a flow diagram illustrating the method according to the present invention; and

FIG. 2 is a flow diagram illustrating procedures for processing ties.

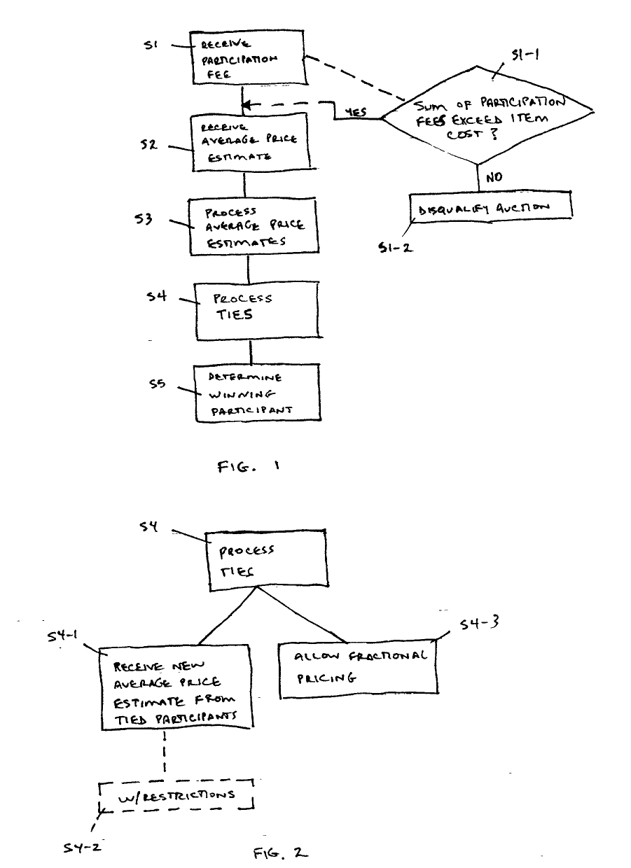

### DETAILED DESCRIPTION OF PREFERRED EMBODIMENTS

The auction system and method according to the present invention can effect a quiz format auction or competitive auction using one of several venues and/or media forms. In one method, players can participate in the auction via the internet (exclusively or with the other methods as discussed below) using standard internet protocol with dedicated software. In this context, the software and programming of the system for carrying out the competitive auction method according to the invention do not form part of the present invention and will thus not be further described. Those of ordinary skill in the art will contemplate various known means for such software and programming, and the invention is not meant to be limited to any particular means.

Alternatively, participants may physically attend an auction venue using hand held devices or the like capable of registering at that location. A conventional balloting system may also be used instead of the hand held devices, although conventional balloting would require manual processing, which of course would result in unnecessary time consumption. The hand held devices will typically enable the participant to input some identification, possibly input the item for which the estimate is being supplied, and the estimate for processing by a processing system. The hand held device itself does not form part of the present invention, and details thereof will not be further described. Generally, however, the hand held device can be any suitable form of data entry and storage device with communication ability, either wired or wireless. Of course, those of ordinary skill in the art will contemplate many suitable alternatives, and the invention is not meant to be limited to any particular data entry device.

In a third mode of operation, the auction can be held at a physical auction site but with possible hand held device capability from remote locations, e.g., by closed circuit television, internet streaming video, etc.

Referring to the figures, in the competitive auction according to the present invention, in step S1, a participation fee is received from each of the plurality of participants. In one embodiment (step S1-1), the method requires that the sum of the participation fees exceeds the cost of the item, preferably by an amount sufficient to provide a profit to the auction venue or sponsor. In this embodiment, if the sum of the participation fees does not exceed the cost of the item, the auction may be disqualified (step S1-2). If the participation fees are sufficient, the auction can proceed. Alternatively, a smaller participation fee can be received from the participants, and the winning participant can be required to pay for the item an amount that provides a profit for the auction organizer. The amount would necessarily be considerably discounted from the actual retail cost of the item so the winning participant still feels as though they have “won” the auction. The auction venue or sponsor may also adjust the participation fee higher or lower on a product by product basis and/or based on a number of participants.

Moreover, the participation fee may be provided via non-monetary contributions according to auction venue or sponsor preference. Such non-monetary items may include frequent flyer miles, casino promotional credit awards, credit card “use” dollars, entertainment, retail or services loyalty credit awards, corporate programs, internet participation and the like. For example, an airline or airline affiliate may accept frequent flyer miles as the participation fee. In a casino context, players may be awarded promotional credits or the like based on an amount of time played or money lost in the casino. In a similar context, the participation fee may be provided using accumulated non-denominated fractional payouts as described in co-pending U.S. patent application Ser. No. 09/961,312, filed Sep. 25, 2001, the contents of which are herein incorporated by reference. Of course, still other monetary or non-monetary means may be suitable for the participation fee, and the invention is not necessarily meant to be limited to the described examples.

After receiving the participation fee from each of the participants, the participants provide a guess of an average price estimate for the auctioned item among the participants. That is, each participant has to estimate the average price that will be offered by all participants. As will be apparent, the average price estimated by all participants will not necessarily correspond with the actual cost of the item. In step S3, the average price estimates are processed in any suitable manner, e.g., using a computer, manually, etc., and the closest estimate wins the auction for that item.

In the event of a tied estimate, ties can be processed in any of several ways (step S4). Referring to FIG. 2, in step S4-1, the tied participants may simply be required to submit a new estimate. In this context, there may be complete freedom of choice with respect to the second estimate, or there may be restrictions (step S4-2). For example, the tied participants may be required to submit an estimate that is different from their first round estimate. Alternatively, in step S4-3, fractional pricing may be permitted for estimates in a second round or a third round only. In this context, for example, if first round estimates are provided to a nearest dollar, second round estimates for resolving ties may include values less than $1 or even less than 1¢. Of course, fractional pricing may also be permitted in the first round average price estimates from the participants (step S2), which would significantly reduce the chance for a tied estimate.

After processing any ties, the winning participant is determined in step S5.

This methodology allows the sale of an item, such as a new car for example, by auction with all participants having an equal opportunity to use skill in estimating the correct average price as the average of price is estimated by all participants. Moreover, the methodology allows high turnover of premium price items without extensive ongoing marketing. The combined auction and game concepts according to the present invention will attract participants while enabling participants of all income levels to participate in auctions for high price items.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of conducting an auction for an item, the method comprising:
(a) receiving a participation fee from each of a plurality of participants;
(b) the participants each guessing an average price estimate for the item among the participants; and
(c) awarding the item to a winning participant whose average price guess is closest to the average price estimate among the participants.

2. A method according to claim 1, wherein upon the occurrence of more than one winning participant when two or more of the participants' average price guesses are tied as closest to the average price estimate among the participants, step (c) is practiced by receiving new average price guesses from the tied participants, and awarding the item to the winning participant whose new average price guess is closest to the average price estimate among the participants.

3. A method according to claim 2, wherein the step of receiving new average price guesses is practiced by putting restrictions on the new average price guesses relative to the tied average price guesses.

4. A method according to claim 2, wherein upon the occurrence of a tie after receiving the new average price guesses, step (c) is practiced by receiving second new average price guesses from the tied participants, and awarding the item to the winning participant whose second new average price guess is closest to the average price estimate among the participants.

5. A method according to claim 2, wherein the step of receiving new average price guesses is practiced by allowing fractional pricing for the new average price guesses.

6. A method according to claim 1, wherein step (b) is practiced by allowing fractional pricing.

7. A method according to claim 1, wherein the auction is conducted over a global computer network.

8. A method according to claim 1, wherein the auction is conducted using hand-held bidding devices.

9. A method according to claim 1, further comprising requiring that a sum of the participation fees received in step (a) exceeds a cost of the item.

10. A method according to claim 1, wherein step (a) is practiced by receiving a non-monetary contribution according to auction venue or sponsor preference.

11. A method of conducting a competitive auction for an item with a plurality of participants, the method comprising receiving an average price estimate guess for the item among the participants from each of the participants, determining the average price estimate among the participants, and awarding the item to a winning participant whose average price estimate guess is closest to the average price estimate among the participants.

12. A method according to claim 11, further comprising receiving a participation fee from each of the participants.

13. A method according to claim 12, further comprising requiring that a sum of the participation fees exceeds a cost of the item.

14. A method according to claim 12, wherein the step of receiving a participation fee comprises receiving a non-monetary contribution according to auction venue or sponsor preference.

15. A system for conducting an auction for an item, the system comprising:
means for receiving a participation fee from each of a plurality of participants, the participants each guessing an average price estimate for the item among the participants; and
means for awarding the item to a winning participant whose average price guess is closest to the average price estimate among the participants.

16. A system for conducting a competitive auction for an item with a plurality of participants, the system comprising means for receiving an average price estimate guess for the item among the participants from each of the participants, means for determining the average price estimate among the participants, and means for awarding the item to a winning participant whose average price estimate guess is closest to the average price estimate among the participants.
